(19) United States
(12) Patent Application Publication
(10) Pub. No.: US 2014/0120329 A1
(43) Pub. Date: May 1, 2014

(54) DECORATION FILM, DECORATED MOLDED DEVICE AND DECORATION MOLDING PROCESS

(71) Applicant: ETANSI INC., Taoyuan County (TW)

(72) Inventors: Shih-Chiang Hu, Taoyuan County (TW); Shih-Min Huang, Taipei City (TW); Fang-Yu Su, Taoyuan County (TW)

(73) Assignee: ETANSI INC., Taoyuan County (TW)

(21) Appl. No.: 13/688,145

(22) Filed: Nov. 28, 2012

(30) Foreign Application Priority Data
Oct. 26, 2012 (TW) 101139779

(51) Int. Cl. B32B 27/08; B32B 7/02

(52) U.S. Cl. CPC B32B 27/08; B32B 7/02
USPC 428/201; 156/241

(57) ABSTRACT

A decoration film, a decorated molded device, and a decoration molding process are provided. The decoration film includes a carrier layer; a releasing layer disposed on the carrier layer; a protection layer, wherein the releasing layer is located between the protection layer and the carrier layer; a decoration pattern layer disposed on the carrier layer; an impact resisting layer disposed on the carrier layer; an adhesion layer disposed on the carrier layer, wherein the total film thickness of the adhesion layer and the impact resisting layer is 2 μm to 20 μm and the impact resisting layer and the decoration pattern layer are located between the protection and the adhesion layer.

### CROSS-REFERENCE TO RELATED APPLICATION

This application claims the priority benefit of Taiwan application serial no. 101139779, filed on Oct. 26, 2012. The entirety of the above-mentioned patent application is hereby incorporated by reference herein and made a part of this specification.

### BACKGROUND

1. Technical Field

The invention relates to a molded body and a manufacturing method thereof, and particularly relates to a decoration film, a decorated molded device and a decoration molding process.

2. Description of Related Art

Conventionally, a pattern or a decoration formed on the plastic molded article or the metal molded article is mainly manufactured by a spraying process or a printing process to present the specific visual effect. However, due to the drawbacks of time-wasting and process complexity, the spraying process is not facilitated to mass production.

In order to solve aforementioned problems, in-mold decoration (IMD) techniques have been provided, wherein such IMD techniques generally include In-Mold Roller (IMR), In-Mold Label (IML), Heat Transfer Printing, Sublimation Heat Transfer, Hot Stamping, Ink-Jet Printing and Water Transfer Printing, etc. All of these IMD techniques are performed by forming a decoration layer having the desired visual effect on a carrier layer (i.e., a carrier substrate) so as to constitute a decoration film, and then boning a molded article to the decoration layer during the manufacturing step of the molded article (such as a mold ejection process of the plastic molded body or a punching process of the metal molded body) so as to constitute a decorated molded article. In some IMD techniques, the carrier substrate of the decoration film is removed, alternately, in other IMD techniques, the carrier substrate of the decoration film may not be removed.

However, the decoration film is impacted in the process of manufacturing a molded article. With respect to the plastic molded article, the decoration film is impacted by the injection of a plastic material in a step of the mold ejecting process. With respect to the metal molded article body, the decoration film is also impacted by a stress of the punch step. Therefore, an issue is commonly raised that the decoration layer is damaged by the impact thereon during the decoration molding process, for example, an ink breakage may occurs due to an impact on a ink pattern of the decoration layer in the molding process.

### SUMMARY

The invention is directed to a decoration film having a desirable impact resisting characteristic.

The invention is directed a decorated molded device having a desirable appearance.

The invention is directed a decoration molding process, which is not prone to cause damage on a decoration film.

The invention provides a decoration film. The decoration film includes a carrier layer; a releasing layer disposed on the carrier layer; a protection layer disposed on the carrier layer, wherein the releasing layer is disposed between the protection layer and the carrier layer; a decoration pattern layer disposed on the carrier layer; an impact resisting layer disposed on the carrier layer; and an adhesion layer, disposed on the carrier layer, wherein a total film thickness of the impact resisting layer and the adhesion layer is 2 μm to 20 μm, and the impact resisting layer and the decoration pattern layer are located between the protection layer and the adhesion layer.

The invention further provides a decorated molded device. The decorated molded device includes a molded body; an adhesion layer contacted with a surface of the molded body; a decoration pattern layer disposed on the adhesion layer; an impact-resisting layer disposed on the adhesion layer; and a protection layer disposed on the adhesion layer and the decoration pattern layer. The impact resisting layer is located between the protection layer and the adhesion layer, wherein a total film thickness of the impact resisting layer and the adhesion layer is 2 μm to 20 μm.

According to an embodiment of the invention, the total film thickness of the impact resisting layer and the adhesion layer is 5 μm to 15 μm.

According to an embodiment of the invention, a glass transition temperature (Tg) of the impact resisting layer is 90° C. to 140° C.

According to an embodiment of the invention, a glass transition temperature (Tg) of the impact resisting layer is 110° C. to 120° C.

According to an embodiment of the invention, a material of the impact resisting layer includes polyacrylic polyol.

According to an embodiment of the invention, a material of the adhesion layer is resin.

According to an embodiment of the invention, a material of the adhesion layer is polyvinylchloride (PVC) resin.

According to an embodiment of the invention, the protection layer is a foggy surface at a side away from the adhesion layer.

According to an embodiment of the invention, the decoration pattern layer has at least a foggy background.

According to an embodiment of the invention, the decoration pattern layer is located between the impact resisting layer and the protection layer.

According to an embodiment of the invention, the impact resisting layer is located between the decoration pattern layer and the protection layer.

According to an embodiment of the invention, the molded body includes a plastic material and a plurality of glass fibers distributed in the plastic material, and the impact resisting layer is located between the adhesion layer and the decoration pattern layer. Here, a part of the glass fibers is further inserted into the adhesion layer and all of the glass fibers are not inserted into the decoration pattern layer. To be specific, the plastic material includes nylon, polycarbonate (PC) or acrylonitrile-butadiene-styrene (ABS) resin.

The invention further provides a decoration molding process. The decoration molding process includes: bonding the adhesion layer of the aforementioned decoration film to a molded body and separating the carrier layer from the protection layer by a function of the releasing layer so as to construct a decorated molded device.

According to an embodiment of the invention, the impact resisting layer is located between the decoration pattern layer and the adhesion layer and a method of bonding the adhesion layer of the decoration film to the molded body includes: placing the decoration film in a molded cave of a mold; injecting a plastic material into the molded cave so that the plastic material contacts with the adhesion layer; and ejecting the plastic material from the molded cave so as to form the molded body. A plurality of glass fibers are distributed in the plastic material.

According to an embodiment of the invention, the decoration pattern layer is located between the adhesion layer and the impact resisting layer and a method of bonding the adhesion layer of the decoration film to the molded body includes: bonding a plate and the decoration film; and performing a punching step so that the plate is bended to form the molded body. A material of the plate includes metal.

In view of the above, the impact resisting layer is disposed between the adhesion layer and the decoration pattern layer of the decoration film in the invention. Therefore, in the process of manufacturing the molded body, an ink layer is not prone to be damaged due to an impact on the decoration film so as to obtain a decorated molded device having desirable quality. Additionally, when the glass fibers are distributed in the molded body, a disposition of the impact resisting layer is also facilitated to avoid a fibber floating phenomenon of the glass fibers to maintain the aesthetic appearance of the decorated molded device.

In order to make the aforementioned and other objects, features and advantages of the invention comprehensible, a preferred embodiment accompanied with figures is described in detail below.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1 is a schematic view of a decoration film according to one embodiment of the invention.

FIG. 2 is a schematic view of a decorated molded device manufactured by a decoration molding process using the decoration film depicted in FIG. 1 according to one embodiment of the invention.

FIG. 3 is a schematic view of a decorated molded device manufactured by a decoration molding process using the decoration film depicted in FIG. 1 according to another embodiment of the invention.

FIG. 4 is a schematic view of a decoration film according to another embodiment of the invention.

FIG. 5 is a schematic view of a decorated molded device manufactured by a decoration molding process using the decoration film depicted in FIG. 4 according to one embodiment of the invention.

FIG. 6 is a schematic view of a decoration film according to another embodiment of the invention.

FIG. 7 is a schematic view of a decorated molded device manufactured by a decoration molding process using the decoration film depicted in FIG. 6 according to one embodiment of the invention.

### DESCRIPTION OF EMBODIMENTS

Reference will now be made in detail to the preferred embodiments of the invention, examples of which are illustrated in the accompanying drawings. Wherever possible, the same reference numbers are used in the drawings and the description to refer to the same or like parts.

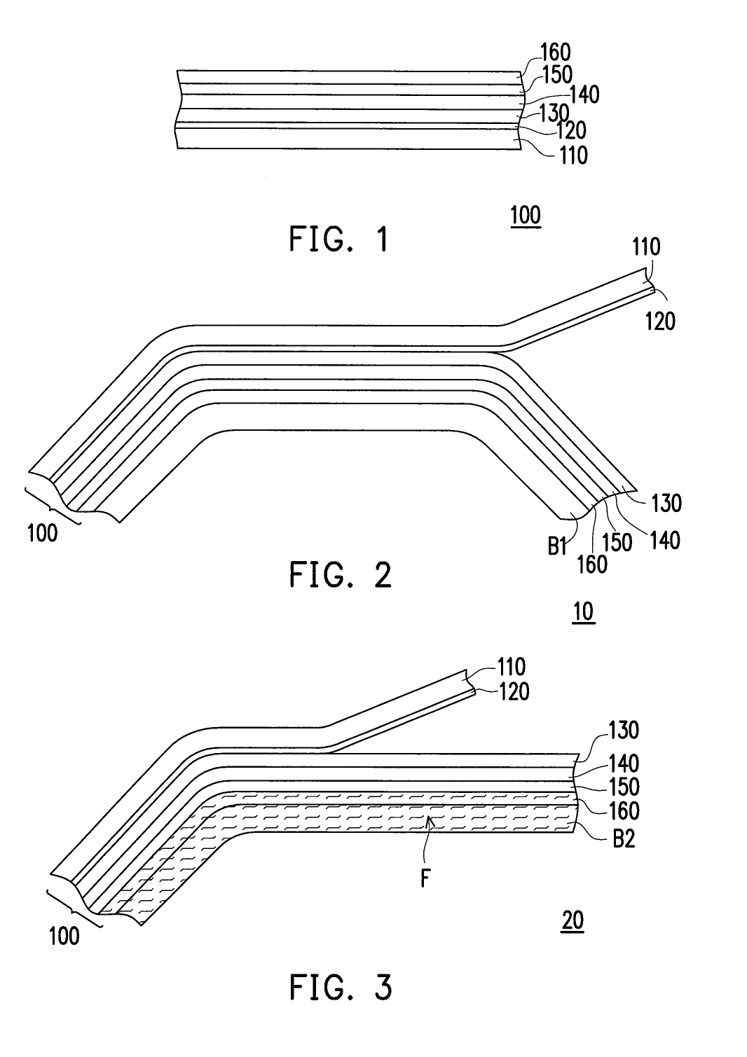

FIG. 1 is a schematic view of a decoration film according to one embodiment of the invention. Referring to FIG. 1, the decoration film 100 includes a carrier layer 110, a releasing layer 120, a protection layer 130, a decoration pattern layer 140, an impact resisting layer 150 and an adhesion layer 160. Herein, the carrier layer 110 is, for example, a layered article having flexible characteristic and capable of carrying the releasing layer 120, the protection layer 130, the decoration pattern layer 140, the impact resisting layer 150 and the adhesion layer 160. In other words, a method of manufacturing the decoration film 100 includes forming the releasing layer 120, the protection layer 130, the decoration pattern layer 140, the impact resisting layer 150 and the adhesion layer 160 on the carrier layer 110 by a film forming method such as coating, printing or depositing. Therefore, the carrier layer 110 described in this embodiment can be viewed as a substrate or a carrier substrate alleged by people skilled in the art.

With respect to this embodiment, the releasing layer 120, the protection layer 130, the decoration pattern layer 140, the impact resisting layer 150 and the adhesion layer 160 are located on the same side of the carrier layer 110 and stacked outward from the carrier layer 110 in sequence. In other words, the impact resisting layer 150 is located between the decoration pattern layer 140 and the adhesion layer 160. The protection layer 130 is located on the decoration pattern layer 140 at a side away from the adhesion layer 160. The releasing layer 120 is disposed between the carrier layer 110 and the protection layer 130.

Additionally, a total film thickness of the impact resisting layer 150 and the adhesion layer 160 is 2 μm to 20 μm. Therefore, when the decoration film 100 and a molded body are bonded to constitute a decorated molded device, the disposition of the impact resisting layer 150 and the adhesion layer 160 is facilitated to ease an impact on the decoration pattern layer 140 in the process of manufacturing the molded body. In other words, the decoration film 100 in this embodiment has a higher endurance capacity to the impact during the process. However, the total film thickness of the impact resisting layer 150 and the adhesion layer 160 is not limited to the aforementioned conditions, the total film thickness of the impact resisting layer 150 and the adhesion layer 160 can selectively configured from 5 μm to 15 μm. Additionally, for providing a desirable impact resisting characteristic, the impact resisting layer 150 can be manufactured by selecting a specific material, but is not limited thereto. In order to disclose the implementation types of the invention adequately, each element of the decoration film 100 is described as follows; however, the scope of the invention is not limited to the following description.

The carrier layer 110 is, for example, a polymer flexible thin film capable of providing the carrying function. A material of the carrier layer 110 can be polymers such as polyethylene terephthalate (PET), polyethylene naphthalate (PEN), polyethylene glycol-co-cyclohexane-1,4 dimethanol terephthalate (PETG), thermalplastic polyurethane (TPU), polyurethane (PU), polypropylene (PP), polycarbonate (PC), amorphous polyethylene terephthalate (A-PET), polyvinyl chloride (PVC), triacetyl cellulose (TAC), polymethylmethacrylate (PMMA), methyl methacrylate-styrene (MMA-st, MS) copolymer, cyclo olefin copolymer (COC), or a combination thereof.

The releasing layer 120 is usually a thin film with low surface tension which can be made of the material selecting from at least one of wax, paraffin, and silicone, or an impermeable thin film with high smoothness and not permeable which can be made of an irradiation curable multi-functional acrylic ester, silicone acrylate, epoxy, vinyl ester, allyl vinyl compound, unsaturated polyester or a mixture thereof A material of the releasing layer 121 can be selected from a polycondensate, a copolymer, a blend, or a mixture consisting of epoxy, polyurethane, polyimide, polyamide, hexa methoxymethyl melamine-formaldehyde, urea-formaldehyde, phenol-formaldehyde, and a combination thereof.

A material of the protection layer 130 includes radiation-cured multi-functional group acrylic ester, epoxide, vinyl ester resion, diallyo(o-)phthalate, vinyl ether or a combination thereof. The radiation-cured multi-functional group acrylic ester can be epoxy acrylate, polyurethane acrylate, polyester acrylate, silicone acrylate or glycidyl acrylate.

The decoration pattern layer 140 can be a colourful ink layer, a black ink layer, a white ink layer or a combination thereof. In one embodiment, such ink layers can be formed by any suitable printing process such as gravure printing process, screen printing process, flexographic printing process, offset printing, reverse printing process, ink jet printing process, so as to form the desired decoration pattern layer 140, and a material of the ink layers can be sublimation type transferring ink, heat-melted type transferring ink, UV-type transferring ink, and the like.

In one embodiment, the decoration pattern layer 140 may include a metal layer or another material layer (not shown) in order to provide a special visual effect such as metallic lustre or a specific touch feel. In other words, in this embodiment, it is not particularly limited that a decoration pattern of the decoration film 100 is constructed by the ink layer or a combination of the ink layer and other material layers. The metal layer provided for decoration can be formed by using a metal material such as Al [symbol] Cu [symbol] Zn [symbol] Sn [symbol] Mo [symbol] Ni [symbol] Cr [symbol] Ag [symbol] Au [symbol] Fe [symbol] In [symbol] Tl [symbol] Ti [symbol] Ta [symbol] W [symbol] Rh [symbol] Pd [symbol] Mg [symbol] Pt [symbol] any alloy thereof or a combination thereof. Further, a method of manufacturing the metal layer includes coating, laminating, plating, sputtering, vacuum evaporating or a combination thereof, but is not limited thereto.

A disposition of the impact resisting layer 150 can provide a desirable impact resisting characteristic in the decoration molding process of manufacturing the decorated molded device. Thus, the impact resisting layer 150 should also have sufficient tolerance to a temperature of the decoration molding process. Therefore, a glass transition temperature (Tg) of the impact resisting layer 150 may be 90° C. to 140° C., or 110° C. to 120° C. Of course, the aforementioned value is only illustrated as an example. In other embodiments, it falls within the scope of the invention as long as the glass transition temperature (Tg) of the impact resisting layer 150 is not less than the temperature required in the decoration molding process. In addition, a material of the impact resisting layer 150 may be selected from acrylic polyol or polymethacrylate having the characteristic of high temperature resisting. This kind of material usually has a desirable degree of crosslinking so as to provide an enhanced characteristic of impact resisting in the decoration molding process.

The material of the adhesion layer 160 can be selected from polyacrylate, polymethacrylate, polystyrene, polycarbonate, polyurethane, polyester, polyamide, epoxy resin, polyvinylchloride (PVC) resin, ethylene vinylacetate copolymer (EVA), thermoplastic elastomer, a copolymer, blend, or a composite thereof. Regarding to this embodiment, if the decoration film 100 is applied to the manufacture of the decorated molded device using a plastic material having higher melting point, a polyvinylchloride (PVC) resin may be used as the adhesion layer 160 to provide the desirable characteristic of thermal resisting. However, the invention is not limit thereto, in other embodiments, a suitable material may be selected to manufacture the adhesion layer 160 depending on the different requirements during the process.

For example, FIG. 2 is a schematic view of a decorated molded device manufactured by a decoration molding process using the decoration film depicted in FIG. 1 according to one embodiment of the invention. Referring to FIG. 2, in the decoration molding process of this embodiment, a molded body B1 is, for example, manufactured by using a mold ejection process, and in the meantime, a part of the elements of the decoration film 100 is bonded to the molded body B1 through the adhesion layer 160. Here, a surface of the molded body B1 may bond with the adhesion layer 160, the impact resisting layer 150, the decoration pattern layer 140 and the protection layer 130. It is worth to note that, the decoration molding process is one of the IMD techniques.

Generally, the IMD technique substantially includes the following steps: placing the decoration film 100 into a molded cave of a mold; injecting a melted plastic material into the molded cave so that the plastic material contacts with the adhesion layer 160; and ejecting the solidified plastic material from the molded cave to form the molded body B1. Here, the protection layer 130, the decoration pattern layer 140, the impact resisting layer 150 and the adhesion layer 160 are ejected from the molded cave along with the molded body B1 so as to construct a decorated molded device 10. Moreover, as shown in FIG. 2, the carrier layer 110 may be separated from the protection layer 130 by a function of the releasing layer 120. Herein, FIG. 2 exemplarily shows a type of the carrier layer 110 been partly peeled off; however, in the practical product, the carrier layer 100 is removed from the molded body B1 completely. In other words, the decorated molded device 10 may not include the carrier layer 110 and the releasing layer 120.

When the decorated molded device 10 is manufactured by the IMD techniques, the injection of the melted plastic material causes the plastic material to impact on the decoration film 100 at a side where the adhesion layer 160 is located. Therefore, in the decoration film 100 of this embodiment, the impact resisting layer 150 is located between the decoration pattern layer 140 and the adhesion layer 160 to prevent from the damage on the decoration pattern layer 140 causing by an impact of an external force during the injecting process of the melted plastic material. In other words, a situation such as ink breakage or pattern damage is not easy to generate on the decoration pattern layer 140.

Generally, the plastic material used in the IMD techniques to manufacture the decorated molded device 10 includes nylon, polycarbonate (PC), polypropylene (PP), polymethylmethacrylate (PMMA), methyl methacrylate-styrene (MMA-st, MS) copolymer, methyl methacrylate-styrene (MS), acrylonitrile butadiene styrene (ABS), polystyrene (PS), polyethylene terephthalate (PET), polyoxymethylene (POM) or a combination thereof.

According to the characteristics of these materials, the manufacturing parameters of the IMD process may be different. Particularly, when the material of the molded body B1 is nylon, the required temperature of the process is higher and the material of the adhesion layer 160 is preferably selected from PVC resin to provide a desirable bonding characteristic. Here, the impact resisting layer 150 is preferably selected from a material having higher glass transition temperature to endure the higher temperature of the process.

Of cause, the invention is not limit thereto. For example, FIG. 3 is a schematic view of a decorated molded device manufactured by a decoration molding process using the decoration film depicted in FIG. 1 according to another embodiment of the invention. Referring to FIG. 3, the manufacturing process of this embodiment is similar to the embodiment described in FIG. 2, and hence no more descriptions are repeated here. A main difference between this embodiment and the embodiment of FIG. 2 is that, a plurality of glass fibers F are distributed in a molded body B2 for manufacturing a decorated molded device 20 in this embodiment. The disposition of the glass fibers F is facilitated to enhance a mechanical strength of the decorated molded device 20.

Note that when the decorated molded device 20 is manufactured by the mold ejecting method, the glass fibers F is mixed in the melted plastic material. In the process of solidifying the melted plastic material to form a molded body B2, due to the fiber floating effect, a part of the glass fibers F is further inserted into the adhesion layer 160. However, according to the disposition of the impact resisting layer 150, all of the glass fibers F are not inserted into the decoration pattern layer 140. As a result, a decorating effect provided by the decoration pattern layer 140 is not influenced and the fiber floating phenomenon is not easy to be felt. Therefore, the disposition of the impact resisting layer 150 may not only prevent from the damage on the decoration pattern layer 140 caused by the impact of the external force, but also reduce the negative influence of the appearance of the decorated molded device 20 caused by the fiber floating phenomenon. Further, in order to avoid seeing the fiber floating phenomenon, the decoration pattern layer 140 of this embodiment may have a foggy background, for example, adding titanium dioxide powder into the decoration pattern layer 140 to construct a background in gray tone so that the decorated molded device 20 has a desirable appearance.

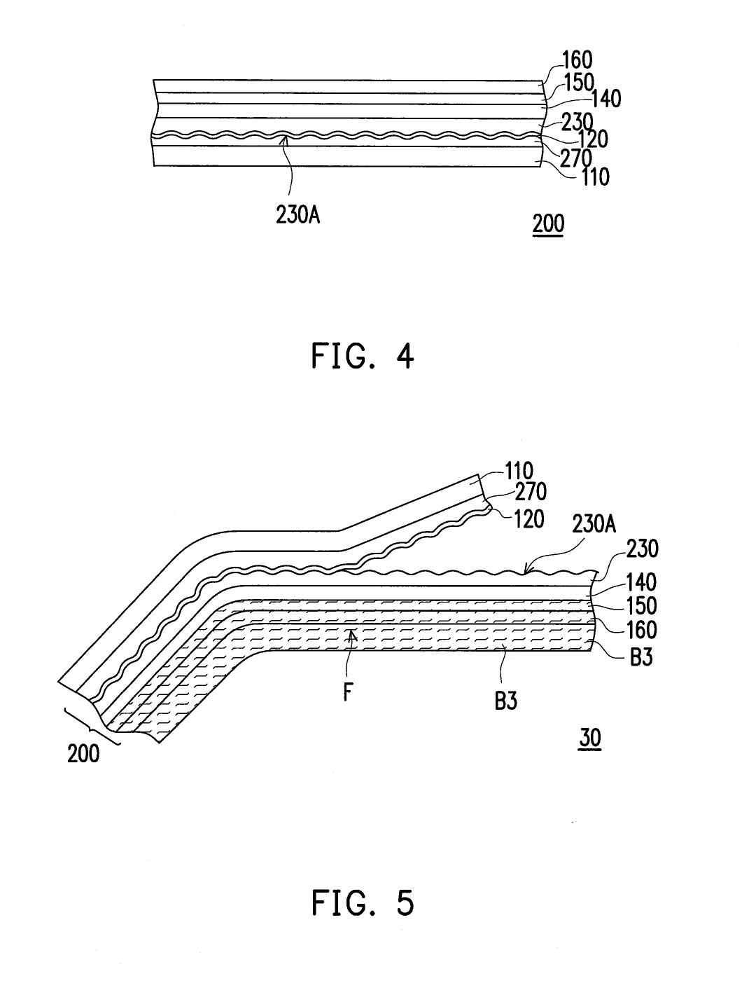

FIG. 4 is a schematic view of a decoration film according to another embodiment of the invention. Referring to FIG. 4, a decoration film 200 is similar to the decoration film 100, thus the same elements in both are denoted with the same reference numbers and not repeated. To be specific, a difference between the decoration film 200 and the decoration film 100 is that, a foggy layer 270 is further disposed between the carrier layer 110 and the releasing layer 120 of the decoration film 200. As a result, the protection layer 230 (i.e., close to the releasing layer 120) has a foggy surface 230A at a side away from the adhesion layer 160.

Regarding to this embodiment, the foggy layer 270 is used to form an uneven structure on the protection layer 230 thereby constructing the foggy surface 230A. Thus, the foggy layer 270 may be a rough structure layer formed by a method such as imprinting or scribing on the carrier layer 110 and also may be an uneven coating layer constructed by a matrix layer mixed with a plurality of particles coated on the surface of the carrier layer 110.

FIG. 5 is a schematic view of a decorated molded device manufactured by a decoration molding process using the decoration film depicted in FIG. 4 according to one embodiment of the invention. Referring to FIG. 5, the step of the process in this embodiment can refer to the relative descriptions about FIG. 3 and FIG. 2 and is not repeated. In this embodiment, a molded body B3 may be constructed by the plastic material and the glass fibers F distributed in the plastic material. It can be known from the above embodiments that, although the disposition of the glass fibers F may be facilitated to enhance the mechanical strength of a decorated molded device 30, the fiber floating phenomenon caused by the glass fibers F leads to an inferior influence to the appearance of the decorated molded device 30. Therefore, in the decorated molded device 30 of this embodiment, the foggy surface 230A of the protection layer 230 renders the fiber floating phenomenon caused by the glass fibers F unnoticeable and facilitates a desirable appearance to the decorated molded device 30.

It is worthy to note that, a combination of the protection layer 230 having the foggy surface 230A and the molded body B3 having the glass fibers F is described in this embodiment; however, it is only described as an example and is not intended to limit the scope of the invention. In other embodiment, such as the embodiment illustrated in FIG. 2, the protection layer may also have a foggy surface depending on the design requirement.

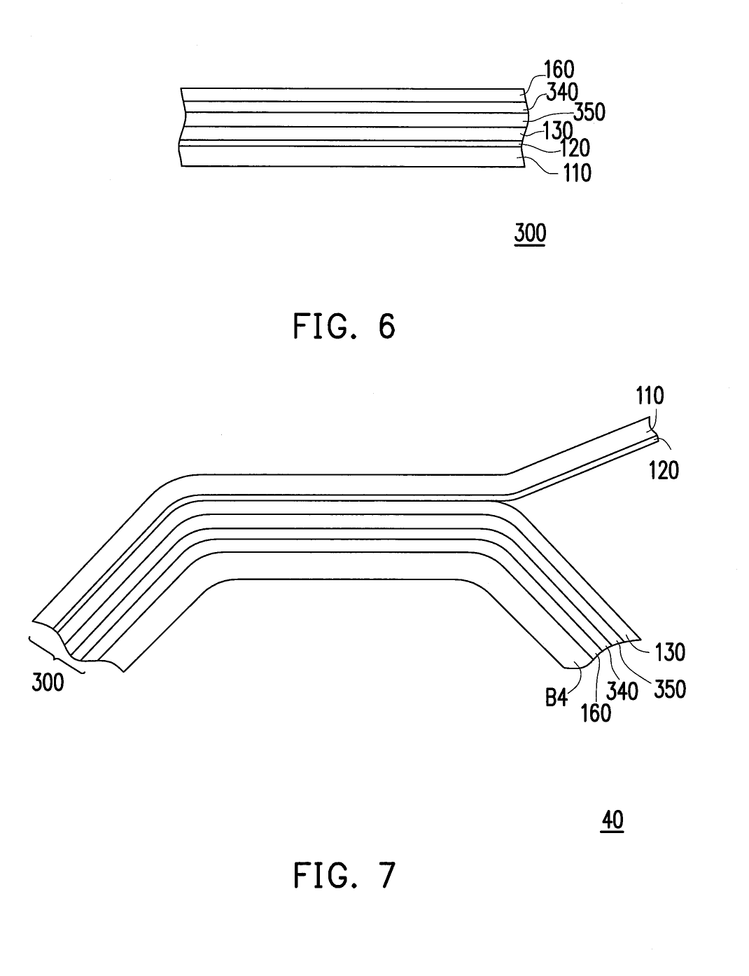

FIG. 6 is a schematic view of a decoration film according to another embodiment of the invention. Referring to FIG. 6, a decoration film 300 is similar to the decoration film 100, thus the same elements of both is depicted with the same device symbols. To be specific, a main difference between the decoration film 300 and the decoration film 100 is that, a decoration pattern layer 340 is located between the adhesion layer 160 and an impact resisting layer 350. In other words, a disposition sequence of the decoration pattern layer 340 and the impact resisting layer 350 is different from the design of the decoration film 100. Herein, the materials of the carrier layer 110, the releasing layer 120, the protection layer 130, the impact resisting layer 350, the decoration pattern layer 340 and the adhesion layer 160 can refer to the relative descriptions of the decoration film 100.

FIG. 7 is a schematic view of a decorated molded device manufactured by a decoration molding process using the decoration film depicted in FIG. 6 according to one embodiment of the invention. Referring to FIG. 7, in this embodiment, a molded body B4 of a decorated molded device 40 is, for example, manufactured by a plate using a punching process, and a material of the plate may be a metal. Therefore, a manufacturing method of the decorated molded device 40 includes, for example, bonding the decoration film 300 illustrated in FIG. 6 to the plate through the adhesion layer 160 of the decoration film 300, and then bending the plate to form the molded body B4 by the punching process. After the molded body B4 is bent to a predetermined shape, the carrier layer 110 can be separated from the decorated molded device 40 by a releasing function of the releasing layer 120.

In the punching process, for example, a fixture impacts the plate and the decoration film 300 from a side where the carrier layer 110 is located. In other words, the decoration film 300 is impacted by an external force P of the fixture. Here, the impact resisting layer 350 of the decoration film 300 is located between the decoration pattern layer 340 and the carrier layer 110 to prevent from the damage on the decoration pattern layer 340 caused by the external force P so that the decorated molded device 40 has a desirable quality.

In conclusive, in the embodiments of the invention, the impact resisting layer is disposed on the decoration pattern layer at a side predetermined to receive an impact so as to enhance the impact resisting characteristic of the decoration pattern layer. Additionally, when the plastic material is used to manufacture the decorated molded device and the glass fibers are added into the plastic material, the decorated molded device may have improved mechanical strength, and the disposition of the impact resisting layer may alleviate the influence of the appearance caused by the fiber floating phenomenon of the glass fibers. Further, the protection layers having the foggy surface disposed in the decoration film and the decorated molded device conduces to reduce the influence of the appearance of the decorated molded device caused by the fiber floating phenomenon of the glass fibers.

The invention has been disclosed above in the preferred embodiments, but is not limited to those. It is known to persons skilled in the art that some modifications and innovations may be made without departing from the spirit and scope of the invention. Therefore, the scope of the invention should be defined by the following claims.

What is claimed is:

1. A decoration film, comprising:
a carrier layer;
a releasing layer, disposed on the carrier layer;
a protection layer, disposed on the carrier layer, wherein the releasing layer is disposed between the protection layer and the carrier layer;
a decoration pattern layer, disposed on the carrier layer;
an impact resisting layer, disposed on the carrier layer; and
an adhesion layer, disposed on the carrier layer, wherein a total film thickness of the impact resisting layer and the adhesion layer is 2 μm to 20 μm, and the impact resisting layer and the decoration pattern layer are located between the protection layer and the adhesion layer.

2. The decoration film as claimed in claim 1, wherein the total film thickness of the impact resisting layer and the adhesion layer is 5 μm to 15 μm.

3. The decoration film as claimed in claim 1, wherein a glass transition temperature (Tg) of the impact resisting layer is 90° C. to 140° C.

4. The decoration film as claimed in claim 1, wherein a glass transition temperature (Tg) of the impact resisting layer is 110° C. to 120° C.

5. The decoration film as claimed in claim 1, wherein a material of the impact resisting layer includes polyacrylic polyol or polymethacrylate.

6. The decoration film as claimed in claim 1, wherein a material of the adhesion layer is resin.

7. The decoration film as claimed in claim 1, wherein a material of the adhesion layer is polyvinylchloride (PVC) resin.

8. The decoration film as claimed in claim 1, wherein the protection layer has a foggy surface at a side away from the adhesion layer.

9. The decoration film as claimed in claim 1, wherein the decoration pattern layer has at least a foggy background.

10. The decoration film as claimed in claim 1, wherein the decoration pattern layer is located between the impact resisting layer and the protection layer.

11. The decoration film as claimed in claim 1, wherein the impact resisting layer is located between the decoration pattern layer and the protection layer.

12. A decorated molded device, comprising:
a molded body;
an adhesion layer, contacted with a surface of the molded body;
a decoration pattern layer, disposed on the adhesion layer;
an impact resisting layer, disposed on the adhesion layer; and
a protection layer, disposed on the adhesion layer and the decoration pattern layer and the impact resisting layer being located between the protection layer and the adhesion layer, wherein the a total film thickness of the impact resisting layer and the adhesion layer is 2 μm to 20 μm.

13. The decorated molded device as claimed in claim 12, wherein the total film thickness of the impact resisting layer and the adhesion layer is 5 μm to 15 μm.

14. The decorated molded device as claimed in claim 12, wherein a glass transition temperature (Tg) of the impact resisting layer is 90° C. to 140° C.

15. The decorated molded device as claimed in claim 12, wherein a glass transition temperature (Tg) of the impact resisting layer is 110° C. to 120° C.

16. The decorated molded device as claimed in claim 12, wherein a material of the impact resisting layer includes polyacrylic polyol.

17. The decorated molded device as claimed in claim 12, wherein a material of the adhesion layer is resin.

18. The decorated molded device as claimed in claim 12, wherein a material of the adhesion layer is polyvinylchloride (PVC) resin.

19. The decorated molded device as claimed in claim 12, wherein the protection layer has a foggy surface at a side away from the adhesion layer.

20. The decorated molded device as claimed in claim 12, wherein the decoration pattern layer has at least a foggy background.

21. The decorated molded device as claimed in claim 12, wherein the molded body includes a plastic material and a plurality glass fibers distributed in the plastic material, and the impact resisting layer is located between the adhesion layer and the decoration pattern layer.

22. The decorated molded device as claimed in claim 21, wherein a part of the glass fibers is further inserted into the adhesion layer, and all of the glass fibers are not inserted into the decoration pattern layer.

23. The decorated molded device as claimed in claim 21, wherein the plastic material includes nylon, polycarbonate (PC) or acrylonitrile-butadiene-styrene (ABS) resin.

24. A decoration molding process, comprising:
providing the decoration film as claimed in claim 1; and
bonding the adhesion layer of the decoration film to a molded body, and separating the carrier layer from the protection layer by a function of the releasing layer so as to construct a decorated molded device.

25. The decoration molding process as claimed in claim 24, wherein the impact resisting layer is located between the decoration pattern layer and the adhesion, and a method of bonding the adhesion layer of the decoration film to the molded body comprising:
placing the decoration film in a molded cave of a mold;
injecting a plastic material into the molded cave so that the plastic material contacts with the adhesion layer; and
ejecting the plastic material from the molded cave to form the molded body.

26. The decoration molding process as claimed in claim 25, wherein a plurality of glass fibers are distributed in the plastic material.

27. The decoration molding process as claimed in claim 24, wherein the decoration pattern layer is located between the adhesion layer and the impact resisting layer and a method of bonding the adhesion layer of the decoration film to the molded body comprising:
bonding a plate and the decoration film; and
performing a punching process so that the plate is bended to form the molded body.

28. The decoration molding process as claimed in claim 27, wherein a material of the plate includes metal.
